(19) United States
(12) Patent Application Publication
(10) Pub. No.: US 2025/0296430 A1
(43) Pub. Date: Sep. 25, 2025

(54) ENGINE GRILLE, ASSEMBLY WITH ENGINE GRILLE, AND METHOD OF MANUFACTURING AND USING THE SAME

(71) Applicant: Daimler Truck North America LLC, Portland, OR (US)

(72) Inventors: Dinesh MADUGUNDI, Beaverton, OR (US); Prashant ARORA, Bengaluru (IN)

(21) Appl. No.: 18/863,536

(22) PCT Filed: May 5, 2023
(86) PCT No.: PCT/US2023/021207

§ 371 Date: Nov. 6, 2024

Related U.S. Application Data
(60) Provisional application No. 63/339,231, filed on May 6, 2022.

(51) Int. Cl. B60K 11/08; F01P 7/02; F01P 7/04

(52) U.S. Cl. CPC B60K 11/08; F01P 7/02; F01P 7/04

(57) ABSTRACT

Engine grilles, assemblies with engine grilles, and methods of manufacturing, assembling, and using the same. In one aspect, an engine grille includes a pair of opposite-facing surfaces that extend to a plurality of edges defining a shape of the engine grille. The engine grille may include a plurality of arc-shaped cooling slots that allow fluid communication through the grille, and may in some non-limiting aspects also include a plurality of cooling holes that allow fluid communication through the grille. The configuration of the arc-shaped cooling slots and the cooling holes in the engine grille improves aerodynamics and fluid transfer for cooling during different operational conditions, among other benefits.

### FIELD OF THE INVENTION

The field relates to engine grilles.

### SUMMARY OF THE INVENTION

This summary is intended to introduce a selection of concepts in a simplified form that are further described below in the detailed description section of this disclosure. This summary is not intended to identify key or essential features of the claimed subject matter, nor is it intended to be used as an aid in isolation to determine the scope of the claimed subject matter.

In brief, and at a high level, this disclosure describes, among other things, engine grilles, assemblies with engine grilles, and methods of manufacturing and using the same. In one embodiment, a grille is provided. The grille includes a solid structure with a pair of opposite-facing surfaces that extend to a plurality of distal edges, which generally define a shape of the grille. The grille may include a plurality of cooling slots formed in the solid structure, which define a plurality of channels through the grille. The grille may also include a plurality of cooling holes formed in the solid structure, the cooling holes being located about, around, and/or adjacent to the plurality of cooling slots. In one embodiment, a plurality of arc-shaped cooling slots are spaced along an axis of the grille (e.g., a vertical axis or a horizontal axis) in a sequence of increasing circumferential lengths (e.g., with increasing circumferential lengths from the bottom of the grille toward the top of the grille). Or, stated differently, each arc-shaped cooling slot spaced along the axis has a longer circumferential length than the arc-shaped cooling slot preceding it (e.g., as measured between opposite ends of each cooling slot). The locations, geometries, and relative spacings/orientations of the cooling slots disclosed herein have been demonstrated to improve cooling and/or aerodynamic performance of a grille under different operating conditions. For example, the grilles described herein support increased air ingress during lower-speed and/or higher-load operations, e.g., startup, acceleration, uphill travel, battery charging, and/or other “cooling-associated” operations during which a higher heat load may be produced that needs to be dissipated, and in addition, support reduced air ingress, and increased aerodynamic performance, during higher-speed and/or lower-load operations, e.g., cruising, decelerating, and/or other “aerodynamically-associated”operations during which a lower heat load may be produced that needs to be dissipated, and where there is an increased need for aerodynamic performance due to vehicle speed. The grilles disclosed herein can further achieve these benefits with static configurations, e.g., including grille configurations that are non-mechanized and/or non-actuated. This reduces the complexity, cost, and components necessary to realize such improved performance, among other benefits.

### BRIEF DESCRIPTION OF THE DRAWING

The engine grilles, assemblies with engine grilles, and methods of manufacturing and using the same provided herein are described in detail with reference to the attached drawing figures, which illustrate non-limiting examples of the disclosed subject matter, wherein:

FIGS. 1A-1B depict an engine grille from different perspectives, in accordance with embodiments of the present disclosure;

FIG. 2 depicts a partial cross-section of the engine grille shown in FIGS. 1A-1B, in accordance with embodiments of the present disclosure;

FIG. 3 is an enhanced depiction of the engine grille shown in FIGS. 1A-1B, depicting a cooling slot in detail, in accordance with embodiments of the present disclosure;

FIGS. 4A-4B depict different perspectives of another engine grille, in accordance with embodiments of the present disclosure;

FIG. 5 depicts a partial cross-section of the engine grille shown in FIGS. 4A-4B, in accordance with embodiments of the present disclosure;

FIG. 6 is an enhanced depiction of the engine grille shown in FIGS. 4A-4B, depicting a cooling slot in detail, in accordance with embodiments of the present disclosure;

FIGS. 7A-7B depict separate assemblies incorporating the engine grilles from FIGS. 1A-1B and FIGS. 4A-4B, respectively, in accordance with embodiments of the present disclosure;

FIGS. 8A-8B separately depict an engine grille during a higher-load engine operation and during a lower-load engine operation, in accordance with embodiments of the present disclosure;

FIGS. 9A-9B are generic depictions of a grille under different operating conditions, demonstrating enhanced cooling/aerodynamics, in accordance with embodiments of the present disclosure;

FIG. 10 depicts a block diagram of a method of manufacturing an engine grille, in accordance with embodiments of the present disclosure;

FIG. 11 depicts a block diagram of a method of using an engine grille, in accordance with embodiments of the present disclosure;

FIGS. 12A-12D depict alternative configurations of engine grilles suited for cooling/aerodynamic functions, in accordance with embodiments of the present disclosure; and

FIG. 13 is a block diagram of a method of differentially controlling airflow around and/or through a grille attached to a vehicle, in accordance with embodiments of the present disclosure.

### DETAILED DESCRIPTION OF THE INVENTION

This detailed description is provided in order to meet statutory requirements. However, this description is not intended to limit the scope of the invention described herein. Rather, the claimed subject matter may be embodied in different ways, to include different steps, different combinations of steps, different elements, and/or different combinations of elements, similar to those described in this disclosure, and in conjunction with other present or future technologies. Moreover, although the terms “step” and “block” may be used herein to identify different elements of methods employed, the terms should not be interpreted as implying any particular order among or between different elements except when the order is explicitly stated.

Powertrains, e.g., those that operate using internal combustion, and/or those that operate using electric/battery power, and their associated ground-based transportation systems, can generate heat during operation. This heat is often dissipated/ejected to control thermal conditions in the powertrain, and limit thermal failure. Often, heat generated by a powertrain is ejected using a cooling module that includes one or more radiators that use exterior air as a cooling medium, one or more fans, and/or an engine grille that allows air to travel into and around the cooling module. The rotation of the fan(s) may correspond to the revolutions-per-minute (“RPM”) of the associated powertrain, and the amount of cooling air that passes through the cooling module can depend on vehicle speed and on fan speed. Notably, the amount of heat generated by a powertrain can change based on the operating conditions. For example, when a vehicle/powertrain is operating at a higher-load condition, e.g., is accelerating to increase forward velocity, is climbing a hill, or is otherwise generating a higher power-output that results in a higher amount of generated heat to be controlled or ejected, increased airflow may be desired for cooling purposes. In these instances, the vehicle/powertrain may also be traveling at a lower speed, and thus there may be increased reliance on fan operation for cooling due to otherwise limited airflow through the grille. In addition, in such instances, there may be reduced concern for aerodynamics due to the lower air-resistance present at lower speeds. In contrast, when a vehicle/powertrain is operating at a lower-load condition, e.g., is cruising, is decelerating, or is otherwise generating a lower power-output that results in a lower amount of generated heat to be controlled or ejected, there may be less airflow needed across the powertrain for cooling purposes. In addition, in such instances, there may be a greater concern for aerodynamics, due to the forward speed of the vehicle/powertrain that results in higher air-resistance. In such instances, excess airflow through the cooling module and/or powertrain contributes to such air-resistance and can reduce the efficiency of the powertrain, e.g., by increasing fuel consumption.

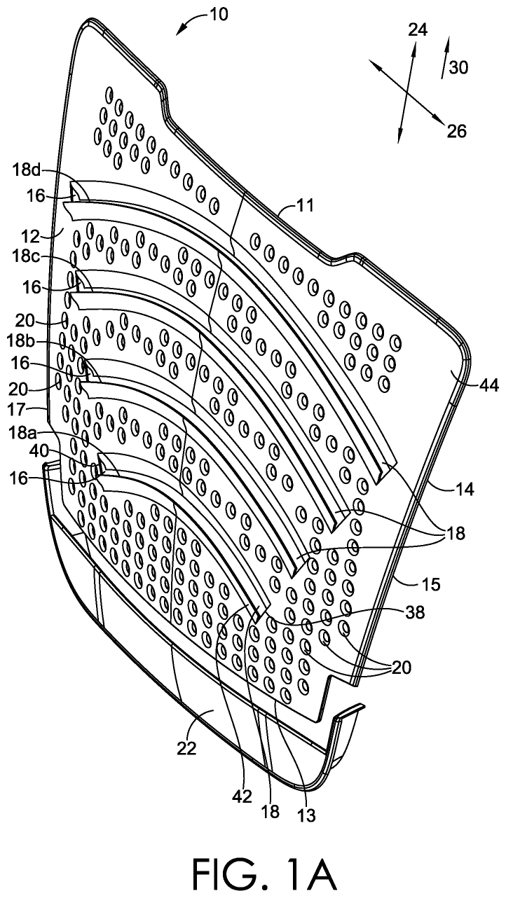

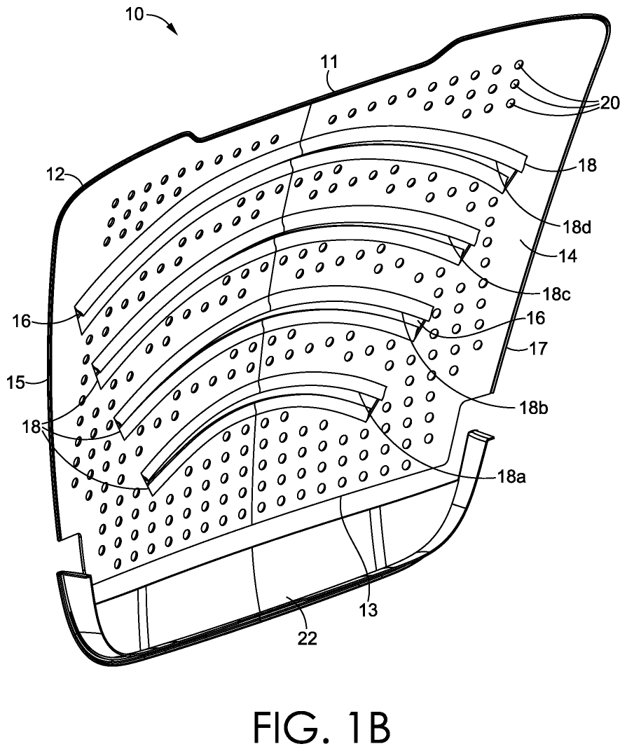

In general, engine grilles, assemblies incorporating engine grilles, and methods of manufacturing and using the same are disclosed herein, among other things. The embodiments disclosed herein enable numerous improvements, e.g., more effective heat transfer and/or heat dissipation during certain engine/powertrain/vehicle operations, e.g., which enhances cooling and engine/powertrain performance, and increased aerodynamics during other engine/powertrain/vehicle operations, e.g., which enhances power output and/or engine/powertrain efficiency. In particular, the grilles disclosed herein may enable increased fluid transfer through the grilles during lower-speed, higher-load operations, e.g., “cooling-associated” operations. The grilles disclosed herein also enable decreased fluid transfer through the grilles and engine/powertrain and increased fluid transfer over the grilles to limit energy loss due to air-resistance during higher-speed, lower-load engine/powertrain operations, e.g., “aerodynamically-associated” operations, e.g., those that benefit from greater aerodynamic performance due to forward speed. These improvements can further be realized with static, e.g., non-mechanized or non-actuated, grille designs, thus limiting the complexity, cost, and components required to achieve such benefits. FIGS. 1-13 illustrate non-limiting embodiments that realize the aforementioned benefits, among others.

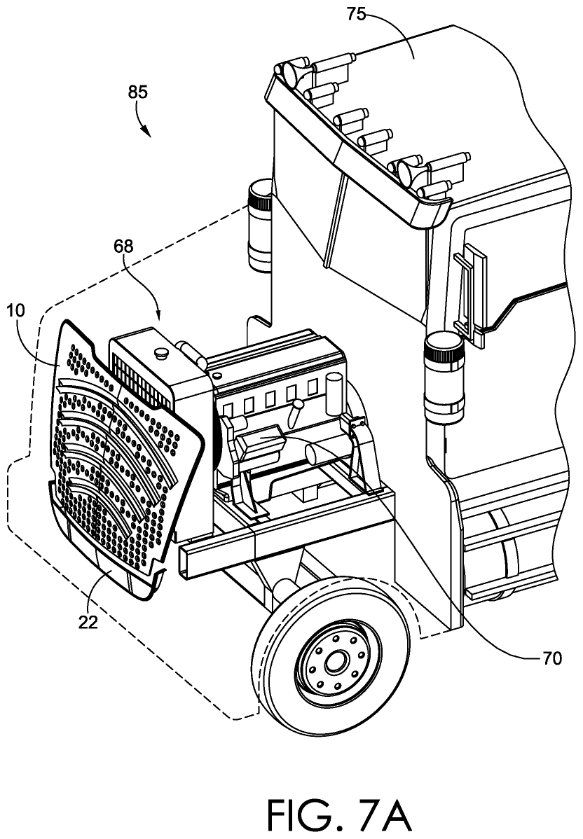

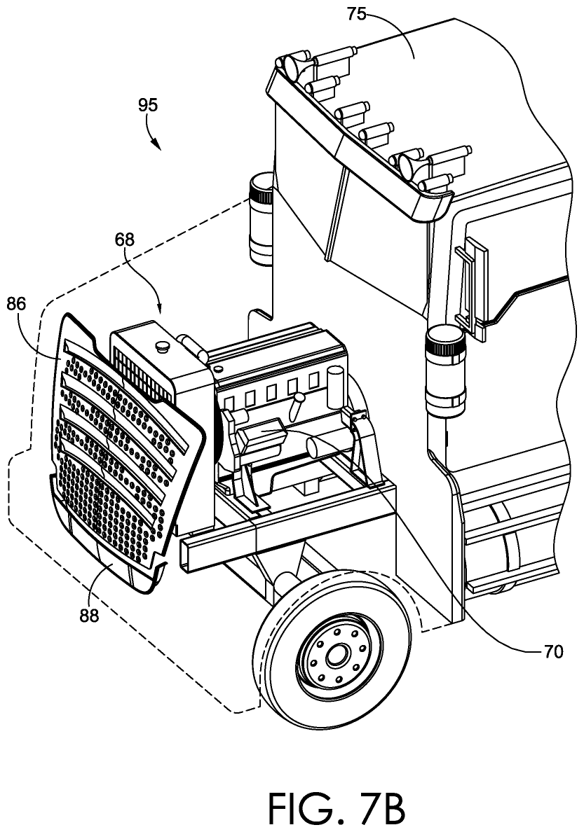

Looking now at FIGS. 1A-1B, a grille 10 is shown, in accordance with an embodiment of the present disclosure. FIG. 1A depicts the grille 10 from one perspective, showing a surface 12 of the grille 10. FIG. 1B depicts the grille 10 from another perspective, showing a surface 14 of the grille 10. The generally opposite-facing surfaces 12, 14 of the grille 10 extend to a plurality of distal edges 11, 13, 15, 17, which together generally define a shape of the grille 10 (e.g., the distal edge 11 may be considered a “top” of the grille 10, the distal edge 13 may be considered the “bottom” of the grille 10, and the distal edges 15, 17 may be considered “sides” of the grille 10, each being relative to an in-use orientation). The surfaces 12, 14 of the grille 10 are each curved, or contoured. More specifically, the surface 12 has a generally convex shape, and the surface 14 has a generally concave shape. This supports an aerodynamic profile of the grille 10, particularly when integrated into an engine assembly, e.g., as shown in FIGS. 7A-7B.

The grille 10 shown in FIGS. 1A-1B includes a plurality of cooling slots 18. In embodiments, the cooling slots formed in grilles described herein can be linear in shape, or can be non-linear in shape, e.g., curved and/or arcuate in shape, e.g., as shown in FIGS. 1A-1B. In some embodiments, a combination of linear cooling slots and non-linear cooling slots may be incorporated into a grille. In embodiments, the cooling slots formed in the grilles described herein can have different sizes, shapes, geometries, widths, heights, depths, and/or radii of curvature, and/or can be oriented along different axes of a corresponding grille compared to what is shown in FIGS. 1A-1B.

In the embodiment depicted in FIGS. 1A-1B, the cooling slots 18 are oriented radially along a vertical axis of the grille 10 (e.g., along axis 24), between distal edges 11, 13, as shown in FIGS. 1A-1B. The plurality of cooling slots 18 define, or delineate, a plurality of cooling channels 16. The cooling channels 16 extend through the grille 10, thereby allowing fluid communication through the grille 10. The grille 10 also includes a plurality of cooling holes 20, only some of which are designated in FIGS. 1A-1B, for clarity purposes. The cooling holes 20 are located about, around, and/or adjacent to the plurality of cooling slots 18, and also allow fluid communication through the grille 10. In other embodiments, a different number of cooling holes 20 can be incorporated into the grille 10, or no cooling holes can be incorporated into the grille 10, while accomplishing similar operational benefits. FIGS. 1A-1B also depict a mount 22, which is configured to support the grille 10, e.g., in an upright, in-use position. In embodiments, this supported position can be 1-30 degrees from a vertical axis. The mount 22 allows the grille 10 to be attached to an engine or powertrain assembly, e.g., one associated with a vehicle. FIGS. 1A-1B depict the grille 10 as a single, solid, integral, unified structure or piece. However, the grille 10 may also be formed from multiple structures/pieces that are assembled together, in other embodiments.

The plurality of cooling slots 18 formed in the grille 10 are spaced along an axis 24 (e.g., a generally vertical axis), which is perpendicular to an axis 26 (e.g., a generally horizontal axis), as identified in FIG. 1A. FIG. 1A also shows how the cooling slots 18 are spaced along the axis 24 in a sequence of increasing lengths, e.g., circumferential lengths. The “circumferential length” of each slot, as discussed herein, is a length measured between opposite ends of the cooling slot 18. To provide one example, the distance between ends 38, 40 of the cooling slot 18a, measured along the arcuate contour of the cooling slot 18a, represents one such “circumferential length” that can be similarly measured on the other cooling slots 18. The cooling slots 18 are spaced along the axis 24, with each cooling slot 18 positioned along the direction 30 having a longer circumferential length than the one preceding it.

In embodiments, a grille can include cooling slots of different shapes. For example, in embodiments, a grille can include cooling slots that are linear or substantially linear in shape, can include cooling slots that are non-linear in shape, e.g., curved, arc-shaped, angled, or otherwise multi-directional, or may include a combination of both. The cooling slots in such embodiments may still be arranged in a sequence of increasing lengths, e.g., along a particular axis, e.g., a vertical axis of the grille so that a shortest-length cooling slot is located towards the bottom of the grille (relative to the vertical axis) and a longest-length cooling slot is located towards the top of the grille (relative to the vertical axis).

The grille 10 shown in FIGS. 1A-1B includes a series of cooling slots 18a, 18b, 18c, 18d the dimensions of which are scalable, e.g., up or down, by a constant value, to obtain larger or smaller configurations of what is shown in FIGS. 1A-1B. FIG. 1A shows how the cooling slots 18a, 18b, 18c, 18d of the grille 10 are arranged in a sequence of increasing circumferential lengths along a positive direction 30 of the axis 24. The cooling slot 18a has a first circumferential length and a first radius; then, spaced along the axis 24 in the positive direction 30, the next cooling slot 18b has a second circumferential length that is greater than the first circumferential length and a second radius that is greater than the first radius; then, spaced along the axis 24 in the positive direction 30, the next cooling slot 18c has a third circumferential length that is greater than the first and second circumferential lengths and has a third radius that is greater than the first and second radii; then, spaced along the axis 24 in the positive direction 30, the next cooling slot 18d includes a fourth circumferential length that is greater than the first, second, and third circumferential lengths and has a fourth radius that is greater than the first, second, and third radii. As shown in FIG. 1A, the cooling slots 18a, 18b, 18c, 18d are positioned on the grille 10 to generally define a radiating-like configuration, e.g., with a series of circumferentially longer slots spaced outward along a common radial direction, and from a common circle center. In embodiments, a given slot may not have a constant radius or curvature, but instead may have a varied radius or curvature along a portion or along the whole of the length of the slot, in aspects.

Looking still at FIGS. 1A-1B, it can be seen that the plurality of cooling holes 20 are located generally about, around, and/or adjacent to the cooling slots 18a, 18b, 18c, 18d. The cooling holes 20 allow for additional fluid transfer through the grille 10, e.g., for engine/powertrain cooling, or around the grille, e.g., for aerodynamics, depending on the operational circumstances. While the grille 10 shown in FIGS. 1A-1B includes circular cooling holes, cooling holes of other geometries and sizes may be used. For example, cooling holes that are oval-shaped, elliptical-shaped, racetrack-shaped, square-shaped, rectangle-shaped, or cooling holes defining another multi-lateral shape, may also be used including in combination to provide different cooling characteristics. The cooling holes 20 may also define different pathway-geometries through the grille 10, e.g., defining a tube-shape having a constant diameter, or defining a conical-shape and/or a funnel-shape having a changing diameter. In addition, the size, shape, and/or relative spacing of the cooling holes 20 may be adjusted in different embodiments, e.g., to adjust or tune the cooling/aerodynamic properties to particular performance needs.

In embodiments, a different number of cooling holes 20 can be present in the grille 10. For example, fewer cooling holes 20 can be present in the grille 10 compared to what is shown in FIGS. 1A-1B, or the cooling holes 20 can be omitted entirely from the grille 10, or more cooling holes 20 can be present in the grille 10 compared to what is shown in FIGS. 1A-1B. In embodiments, the cooling holes 20 can have different dimensions, e.g., smaller or larger diameters, e.g., compared to the dimensions of the cooling holes 20 shown in FIGS. 1A-1B, and/or relative to the dimensions of the cooling slots 18 shown in FIGS. 1A-1B. In embodiments, the cooling holes 20 can differ in size (e.g., at least some of the cooling holes may have different diameters compared to each other). In embodiments, a grille may include cooling holes arranged in different densities, e.g., higher density areas and lower density areas (as measured by the number of cooling holes per square meter). In embodiments, the number of cooling holes incorporated into a grille and/or the density of cooling holes incorporated into a grille can be selected based on a desired amount of fluid transfer through the grille to similarly adjust or tune the cooling/aerodynamic properties to particular performance needs.

FIGS. 1A-1B depict one possible configuration of a grille that provides improved cooling and aerodynamics under different operating conditions. However, grilles having different configurations are also contemplated herein. For example, alternative grilles may have different numbers of cooling slots, e.g., arc-shaped cooling slots and/or linear cooling slots, and/or may include a different numbers of cooling holes, or may have cooling slots and/or cooling holes of different sizes, shapes, positions, orientations, and/or relative dimensions, depending on the cooling/aerodynamic characteristics that are desired in a particular grille.

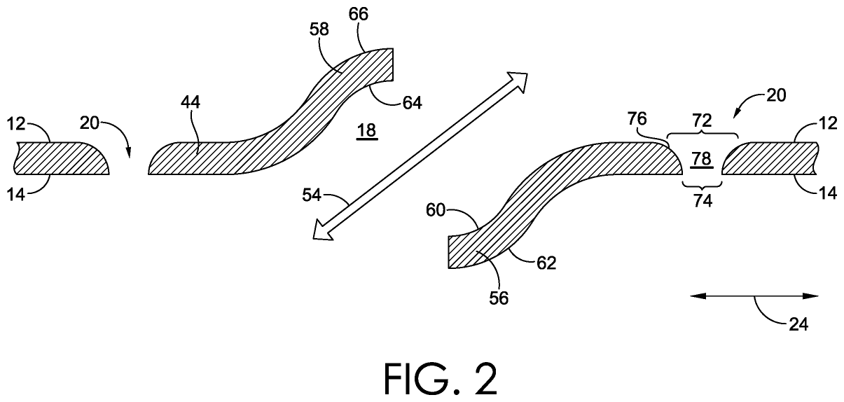

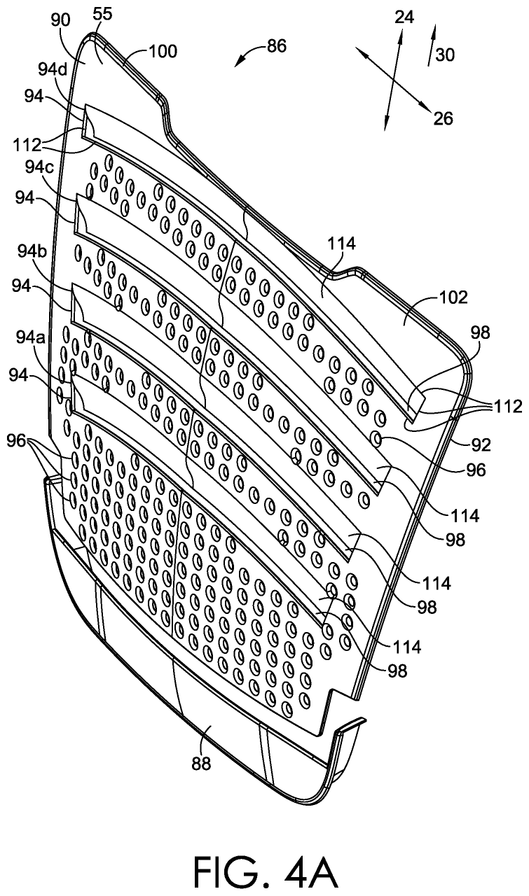

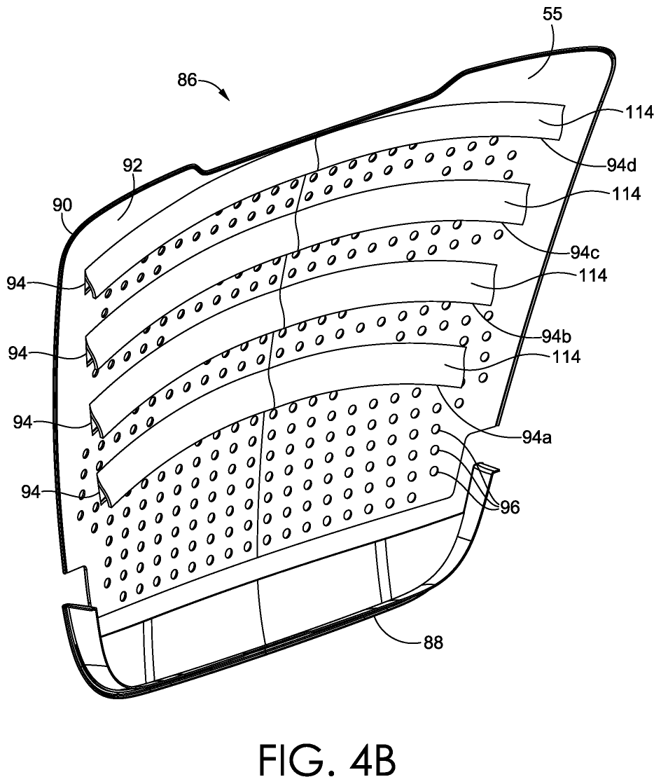

Looking now at FIG. 2, a partial cross-section of the grille 10 is shown, in accordance with an embodiment of the present disclosure. The cross-section shown in FIG. 2 looks along the axis 26, as identified in FIG. 1A. FIG. 2 depicts a grille-structure 44, which generally defines the geometry of the grille 10. FIG. 2 also shows the surface 12, the surface 14, and one of the cooling slots 18 formed in the grille-structure 44. The grille-structure 44 may be formed from various materials. For example, the grille-structure 44 may be formed of one or more metals, metal alloys, plastics, e.g., thermoplastics or thermosetting plastics, or other polymer-based or composite-based materials, e.g., graphite-reinforced polymers, such as carbon fiber. The grilles described in detail herein, e.g., the grille 10 shown in FIGS. 1A-1B or the grille 86 shown in FIGS. 4A-4B, may be formed of such materials, or combinations thereof, depending on the desired material properties. In addition, the grilles described herein may be manufactured using various manufacturing methodologies. For example, this may include casting, e.g., metal casting or polymer casting, and/or machining, e.g., electrical-discharge machining (“EDM”), boring, or drilling, among other methods.

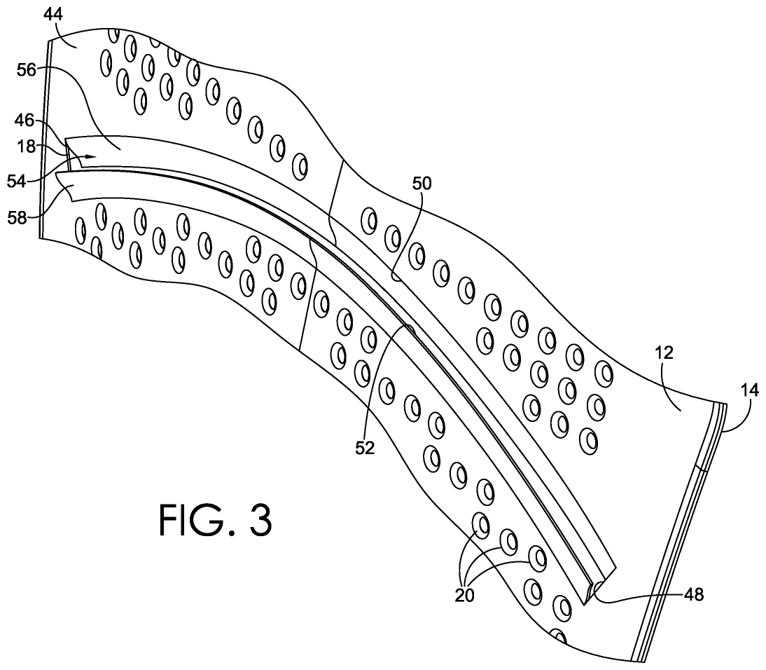

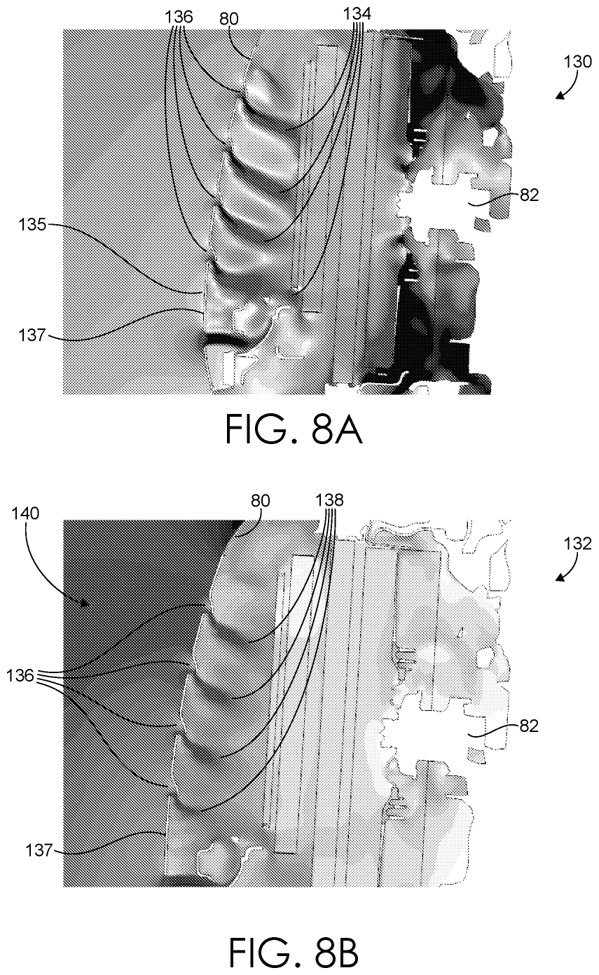

Looking now at FIG. 3, an enhanced depiction of the grille 10, and in particular, one of the cooling slots 18 and the surrounding cooling holes 20 are shown, in accordance with an embodiment of the present disclosure. FIG. 3 depicts the surface 12, the surface 14, and the grille-structure 44 up close. FIG. 3 also shows, in more detail, the design of the cooling slot 18, which includes an end-contour 46, an end-contour 48, an arcuate contour 50 extending between the end-contour 46 and the end-contour 48, and an arcuate contour 52 extending between the end-contour 46 and the end-contour 48. The arcuate contour 50 and the arcuate contour 52 are spaced apart, thereby defining a channel 54 extending through the grille-structure 44. The channel 54 is more clearly depicted in FIG. 2. The cooling slot 18 also includes a curved-extension 56 and a curved-extension 58, which extend in generally opposite or non-aligned directions, as shown in FIGS. 2 and 3. The curved-extensions 56, 58 define at least part of the channel 54. This geometry facilitates different degrees of fluid communication through the cooling slot 18, depending on the operational circumstances, conferring different benefits, as described in detail in connection with FIGS. 8A-8B.

In embodiments, when a cooling slot includes a pair of spaced-apart arcuate contours extending between common end-contours, the spaced-apart arcuate contours may be substantially parallel, e.g., along at least part of their circumferential lengths. In other words, the arcuate contours may be at least partially parallel tangentially, e.g., have parallel tangents at circumferential points on the arcuate contours that extend to a common circle center, or may otherwise be, at least partially, aligned or oriented in a common direction (e.g., having apexes aligned in a common direction, such as along a center vertical axis of the grille). In addition, some arcuate contours may not have this parallel or aligned or oriented configuration, in different embodiments.

Looking back at FIG. 2, the channel 54 can be seen extending through the grille-structure 44, with the curved-extensions 56, 58 defining parts of the channel 54. The curved-extension 56 includes an extension-surface 60 and an opposite-facing extension-surface 62. The extension-surface 60 is generally continuous with the surface 12, and the extension-surface 62 is generally continuous with the surface 14. The curved-extension 58 includes an extension-surface 64 and an extension-surface 66, which faces opposite from the extension-surface 64. The extension-surface 64 is generally continuous with the surface 14, and the extension-surface 66 is generally continuous with the surface 12. The extension-surface 60 of the curved-extension 56 extends generally into and through the cooling slot 18, thereby defining at least part of the channel 54, and the extension-surface 64 of the curved-extension 58 extends generally into and through the cooling slot 18, thereby also defining at least part of the channel 54. The extension-surfaces 60, 64 are spaced apart to define a fluid communication pathway through the channel 54.

FIG. 2 also shows the configuration of the cooling holes 20 formed in the grille 10. In the depicted embodiment, the cooling holes 20 are defined by an aperture 72 formed in the surface 12, an aperture 74 formed in the surface 14, and a sidewall 76 that extends between the aperture 72 and the aperture 74. The sidewall 76 defines a channel 78 that extends through the grille-structure 44. The channel 78 allows for fluid communication through the grille 10. The sidewall 76 shown in FIG. 2 defines a funnel-like shape, due to the aperture 72 being larger than the aperture 74. However, in different embodiments, the cooling hole sidewalls may define different geometries, e.g., being tube-shaped, cylinder-shaped, or conical-shaped, among others. In addition, cooling holes of the same size, shape, and/or geometry, and/or cooling holes of different sizes, shapes, and/or geometries, may be used.

Looking now at FIGS. 4A-4B, another grille 86 is shown, in accordance with an embodiment of the present disclosure. The grille 86 is configured to be attached to a mount 88, which may be attached to an engine/powertrain assembly, e.g., connected to a vehicle. The mount 88 may support the grille 86, e.g., in an upright, in-use position. In embodiments, this supported position can be 1-30 degrees relative to a vertical axis. The grille 86 includes a surface 90, an opposite-facing surface 92, and a plurality of cooling slots 94 spaced along the axis 24 in a series of increasing lengths. In this embodiment, each cooling slot 94 is non-linear in shape, e.g., being curved and/or arc-shaped. However, in other embodiments, the cooling slots 94 can instead be linear in shape, substantially linear in shape, or a combination of linear and non-linear in shape.

Looking at FIG. 4A, the geometry of the grille 86 is defined by a substantially rigid grille-structure 55. In addition, the surface 90 is at least partially convex in shape, and the surface 92 is at least partially concave in shape. This defines a generally aerodynamic contour of the grille 86. The cooling slots 94 are spaced along the axis 24 in a series of increasing circumferential lengths, e.g., with each cooling slot 94 along the direction 30 having a longer circumferential length than the one preceding it, as shown in FIG. 4A. The grille 86 also includes a plurality of cooling holes 96 positioned generally around, about, and/or adjacent to the cooling slots 94, to facilitate additional fluid communication through/around the grille 86 under different operational circumstances. FIGS. 4A-4B, like FIGS. 1A-1B, only identify some of the cooling holes 96, for clarity purposes. The cooling slots 94 each define a channel 98 extending through the grille 86, which allows fluid communication through the grille 86 during associated engine/powertrain operations.

The grille 86 shown in FIGS. 4A-4B has a different configuration than the grille 10 shown in FIGS. 1A-1B. However, the grille 86 is designed to provide similar benefits, including under different operational circumstances, e.g., “cooling-associated” operations and “aerodynamically-associated” operations, as discussed herein. The grille 86 does so with a generally flatter, smoother, and less-contoured surface 90. This provides a more aerodynamic and/or more aesthetically-oriented profile, while achieving similar aerodynamic/cooling benefits. In particular, with the grille 86, the locations and geometries of the cooling slots 94 are modified in comparison to the grille 10, shown in FIGS. 1A-1B. In addition, the location, number, and density of the cooling holes 96 are modified in comparison to the grille 10, shown in FIGS. 1A-1B. The modified design of the grille 86 may be more suitable for applications with larger grille sizes, e.g., larger vehicles. For example, in some instances, a larger grille size may allow for larger cooling slots/holes, allow for more cooling slots/holes, and/or allow for differently distributed cooling slots/holes, among other differences. In some embodiments, the grille 86 can be a single, solid, unified, and/or integral piece. In some embodiments, the grille 86 can be assembled from separate, e.g., distinctly formed or manufactured, pieces, e.g., such as pieces 100, 102 shown in FIGS. 4A-4B.

Looking still at FIGS. 4A-4B, additional structural distinctions in the grille 86 can be seen compared to the grille 10. For example, the relative increase in length, e.g., circumferential length, between each sequentially-longer cooling slot 94 formed in the grille 86, e.g., the cooling slots 94a, 94b, 94c, 94d, may be smaller than the relative increase in length, e.g., circumferential length, between each sequentially-longer cooling slot 18 in the grille 10, e.g., the cooling slots 18a, 18b, 18c, 18d, shown in FIGS. 1A-1B. In addition, the radius of curvature of each cooling slot 94a, 94b, 94c, 94d in the grille 86 may be comparatively larger, e.g., from 1-200 percent larger, or another amount larger, than the radius of curvature of each cooling slot 18a, 18b, 18c, 18d formed in the grille 10. This as a result defines a different geometry of the cooling channels 98 in the grille 86, compared to the cooling channels 16 in the grille 10.

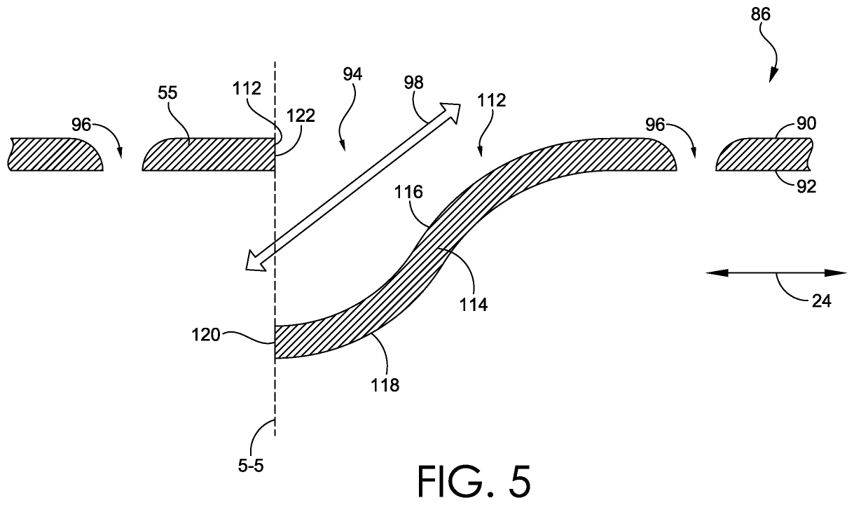

Looking now at FIG. 5, a partial cross-section of the engine grille 86 depicted in FIGS. 4A-4B is shown, in accordance with embodiments of the present disclosure. FIGS. 4A-4B, and in addition FIG. 5, show the geometry of the edge region 112 surrounding one channel 98 extending through the grille-structure 55. FIG. 5 illustrates the differences in this geometry, compared to the geometry of the cooling slot 18 formed in the grille 10, shown in FIGS. 1A-1B and 2. The cooling slot 94 includes a curved-extension 114 forming part of the channel 98, similar to the grille 10 shown in FIGS. 1A-1B. However, unlike the grille 10, the cooling slot 94 does not include an opposed curved-extension defining another part of the channel 98. Rather, with the grille 86, the opposite side of the channel 98 is generally defined by an edge 122, which results in a more planar contour around this area of the cooling slot 94.

Looking still at FIG. 5, the curved-extension 114 includes an extension-surface 116 that is generally continuous with the surface 90 and includes an extension-surface 118 that is generally continuous with the surface 92, and that is generally opposite-facing from the extension-surface 116. The curved-extension 114 generally has a sloping contour, defining a spline-like or S-like shape, as it travels into, and along, the channel 98. This geometry facilitates different degrees of fluid flow into the channel 98, depending on the operating condition of an associated engine/powertrain/vehicle. The curved-extension 114 extends along the axis 24 until the curved-extension 114 reaches a distal end 120 thereof which is generally aligned with the edge 122 of the slot 94 as indicated by line 5-5. In other embodiments, the distal end 120 may not be aligned with the edge 122 as indicated by line 5-5, and instead may stop before, or extend past, the line 5-5 shown in FIG. 5. FIG. 5 also shows cross-sections of the cooling holes 96 formed in the grille 86.

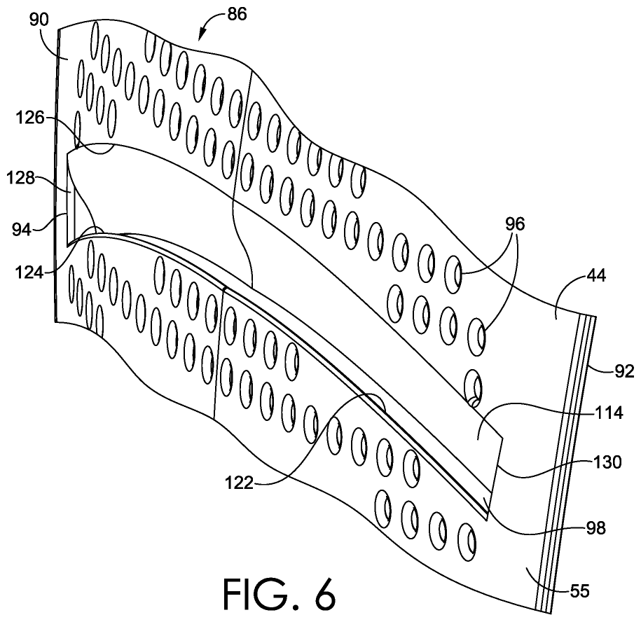

Looking now at FIG. 6, an enhanced depiction of part of the grille 86 shown in FIGS. 4A-4B, showing one of the cooling slots 94 up close, is provided, in accordance with an embodiment of the present disclosure. FIG. 6 shows the geometry of the cooling slot 94 in more detail, and from a different perspective. The cooling slot 94 shown in FIG. 6 has a non-linear shape, e.g., an arcuate-shape in this instance. In other embodiments, the shape can instead be linear, substantially linear, or another non-linear shape. The arcuate-shape of the cooling slots 94 is defined by an end-contour 128, an end-contour 130, and by an arcuate-contour 124 extending between the end-contour 128 and the end-contour 130, and by an arcuate-contour 126 extending between the end-contour 128 and the end-contour 130. The arcuate-contours 124, 126 are spaced apart, and the end-contours 128, 130 are spaced apart, thereby outlining a geometry of the cooling slot 94, and generally defining the channel 98 extending through the grille-structure 55. The edge 122 opposite from the curved-extension 114 is also depicted. Notably, the edge 122 in part helps define a different geometry compared to the cooling slot 18 shown in FIGS. 1A-1B and FIG. 2. The design of the cooling slot 94, like the design of the cooling slot 18, has been demonstrated to improve the fluid flow through/around the grille 86 under different operational conditions, as explained in greater detail in connection with FIGS. 8A-8B.

It should be understood that any of the grilles described herein may or may not include cooling holes in addition to cooling slots. In addition, cooling slots may extend in parallel (e.g., circumferentially parallel in the case of radially-arranged cooling slots, and/or linearly parallel in the case of linearly-arranged cooling slots) and/or not in parallel on such grilles. In addition, cooling slots may extend radially along a vertical axis of the grille, e.g., between a bottom and a top of the grille, and an apex of each cooling slot may be aligned with a vertical axis and/or a central axis of the grille. The circumference of the cooling slots may extend side-to-side on the grille, bottom-to-top on the grille, or some orientation therebetween. In addition, with the grilles described herein, at least 5 percent, at least 10 percent, at least 15 percent, at least 20 percent, at least 25 percent, at least 30 percent, at least 35 percent, at least 40 percent, at least 45 percent, or at least 50 percent, or more, of a surface of the grille may be occupied by the plurality of cooling slots. In addition, each of the cooling slots may extend between 20% and 90% of a width of the grille if oriented along its horizontal axis, or may extend between 20% and 90% of a height of the grille if oriented along its vertical axis.

Looking now at FIGS. 7A-7B, different assemblies 85, 95 incorporating either the grille 10 or the grille 86 are shown, in accordance with embodiments of the present disclosure. FIG. 7A depicts the assembly 85 incorporating the grille 10, shown in FIGS. 1A-1B. FIG. 7B depicts the assembly 95 incorporating the grille 86, shown in FIGS. 4A-4B. FIGS. 7A-7B also each depict a vehicle 75. The vehicles 75 each include an engine/powertrain assembly 68. The engine/powertrain assemblies 68 each include an engine/powertrain 70, e.g., an internal combustion engine, or a powertrain that operates on battery/electric power. In FIG. 7A, the grille 10 is attached to the engine assembly 68 through the mount 22. The grille 10 is positioned in front of the engine 70, and additionally is in front of a fan/blower, obscured by the grille 10 in FIG. 7A. In FIG. 7B, the grille 86 is attached to the engine assembly 68 through the mount 88. The grille 86 is positioned in front of the engine 70, and additionally is in front of a fan/blower, obscured by the grille 86 in FIG. 7B. The incorporation of the grille 10 or the grille 86 enables enhanced fluid transfer through/around the grilles 10, 86 under different operational circumstances, e.g., “cooling-associated” operations, or “aerodynamically-associated” operations, as discussed in connection with FIGS. 8A-8B, below.

Looking now at FIGS. 8A-8B, separate cross-section pressure diagrams 130, 132 are shown, with each depicting fluid transfer through/around a grille 80 under different operational conditions, in accordance with embodiments of the present disclosure. The grille 80 is one designed to realize the cooling/aerodynamic benefits described herein, and therefore may be similar to the grille 10 shown in FIGS. 1A-1B, or similar to the grille 86 shown in FIGS. 4A-4B, or a related design. FIGS. 8A-8B each include a cross-section of the grille 80 and an associated engine/powertrain/fan assembly 82. The degrees of shading shown in FIGS. 8A-8B represent the fluid flow through and/or around the grille 80 during different operational conditions. The darker shading represents a higher amount of fluid flow (e.g., a higher pressure and volumetric flow rate) compared to the lighter shading.

FIG. 8A shows the grille 80 during a higher-load, lower-speed, or “cooling-associated” operation of the assembly 82 as discussed herein. In this operational condition, the assembly 82 is producing a relatively higher power output, e.g., to help initiate forward motion of an attached vehicle. This, as a result, generates a relatively higher heat load. Thus, this operating condition is suitable for higher fluid transfer through the grille 80, e.g., for heat-transfer purposes, because in the “cooling-associated” operational state, there is less concern for aerodynamic fluid transfer over/across the grille 80, because the assembly 82 and attached vehicle are at relatively lower speed. Thus, there is relatively lower air-resistance on the grille 80. FIG. 8A therefore shows, e.g., through the darker shading, a higher degree of fluid transfer/pressure 134 through the cooling slots 136 in the grille 80, compared to FIG. 8B. This higher degree of fluid transfer results in higher heat transfer, and thus capacity to cool the assembly 82 during this “cooling-associated” operational state. This is in contrast to a grille that does not have the cooling/aerodynamic-enhancing design characteristics described herein. The shading 135 near the front 137 of the grille 80 is lighter, indicating a relatively lower degree of aerodynamic fluid transfer over/across the grille 80, compared to FIG. 8B.

FIG. 8B shows the grille 80 during a lower-load, higher-speed, or “cruising” operation of the associated assembly 82. In this operational condition, the assembly 82 is producing a relatively lower power output, e.g., simply to maintain forward motion, and thus generates a relatively lower heat load, e.g., compared to the operation of the assembly 82 shown in FIG. 8A. Thus, this operating condition is suitable for a lower degree of fluid transfer/pressure 138 through the cooling slots 136 in the grille 80, and a higher degree of fluid transfer 140 over/around the grille 80. This is because in the “aerodynamically-associated” operational state, there may be greater need for aerodynamic performance, because the grille 80 and the assembly 82 are traveling at relatively higher speed compared to the “cooling-associated” operational state shown in FIG. 8A, and thus the grille 80 faces greater air-resistance, but requires relatively less fluid transfer/ingress for cooling purposes, compared to FIG. 8A, because of the relatively lower power output required to maintain speed at the “cruising” condition. FIG. 8B shows, through the lighter shading, the relatively reduced fluid transfer/pressure 138 through the cooling slots 136 in the grille 80, and shows, through the darker shading, the relatively increased fluid transfer/pressure 140 over/around the grille 80, correlated with higher aerodynamic performance of the grille 80, in comparison to FIG. 8A. This increased aerodynamic performance in this operating condition is in contrast to a grille that does not have the cooling/aerodynamic-enhancing design characteristics described herein.

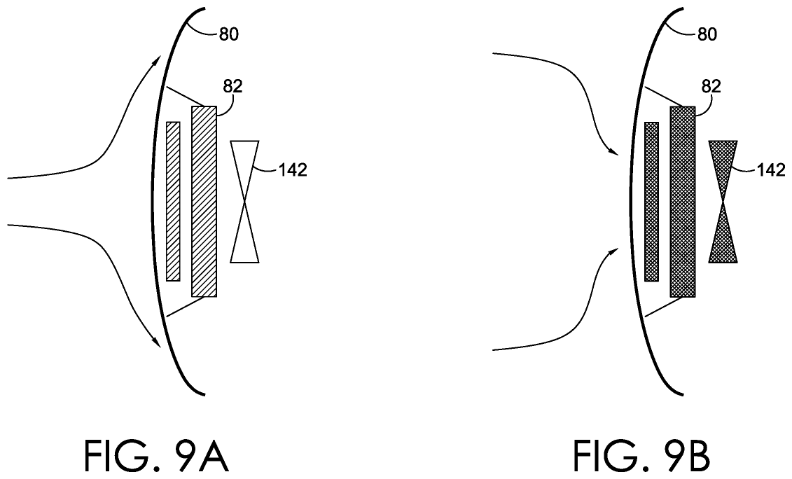

Looking now at FIGS. 9A-9B, generic depictions of the grille 80 discussed in connection with FIGS. 8A-8B, shown under different operating conditions, are provided, in accordance with embodiments of the present disclosure. FIG. 9A generically shows the grille 80 during a lower-load, higher speed, or “aerodynamically-associated” operation, in which higher fluid transfer over/around the grille 80 is occurring, supporting improved aerodynamics, with limited fluid transfer through the grille 80, due to relatively reduced need for cooling of the assembly 82 in this instance. In this operating condition, a fan/motor 142 can be operated at a relatively lower power/speed (or can even be turned off) based on the reduced need for cooling and heat transfer and/or to limit the generation of a pressure differential that could otherwise enhance the transfer of air through the grille 80 in this circumstance. FIG. 9B generically shows the grille 80 during a relatively higher-load, lower-speed, or “cooling-associated” operation, with increased fluid transfer through the grille 80 supporting cooling of the assembly 82, and reduced fluid transfer over/around the grille 80, due to the relatively reduced need for aerodynamic performance in this instance. In this operating condition, the fan/motor 142 can be operated at a relatively higher power/speed based on the increased need for cooling and heat transfer and to help generate a pressure differential that can enhance the transfer of air through the grille 80 in this circumstance. These separate performance benefits can be accomplished even with a substantially static, or substantially fixed, grille design that does not use mechanized, or actuator-driven, components to change the overall geometry of the grille.

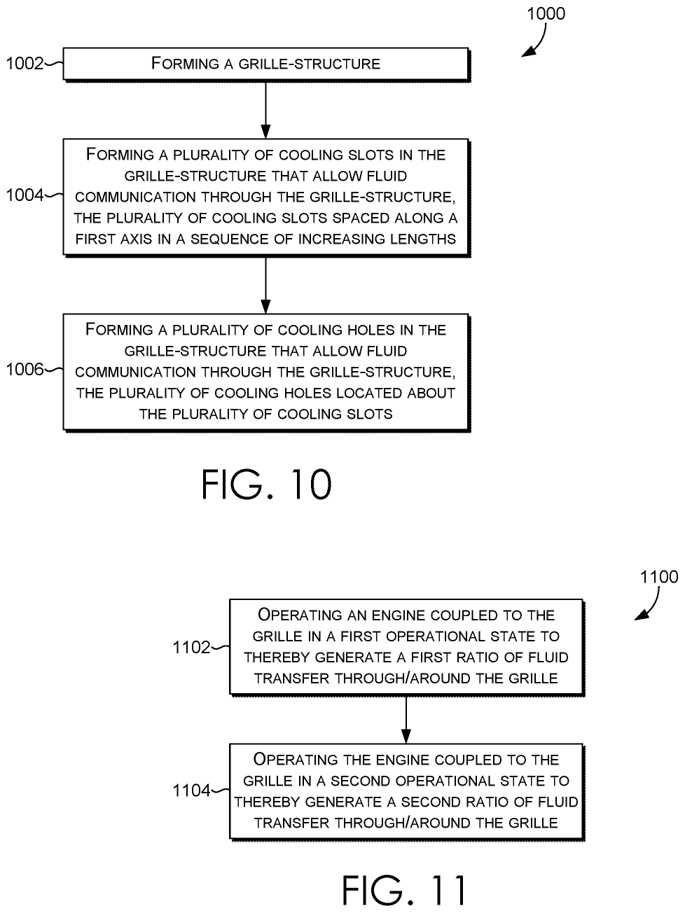

Looking now at FIG. 10, a block diagram of a method 1000 of manufacturing a grille, e.g., the grille 10 shown in FIGS. 1A-1B, is provided, in accordance with an embodiment of the present disclosure. The method 1000 is represented by blocks 1002-1006, but is not limited to this combination of elements. In block 1002, the method includes forming a grille-structure, e.g., such as the grille-structure 44 shown in FIGS. 1A-1B, or the grille-structure 55 shown in FIGS. 4A-4B. The grille-structure may include a first surface, e.g., such as the surface 12 shown in FIGS. 1A-1B or the surface 90 shown in FIGS. 4A-4B, and a second surface, e.g., such as the surface 14 shown in FIGS. 1A-1B or the surface 92 shown in FIGS. 4A-4B. In block 1004, the method includes forming a plurality of cooling slots, e.g., such as the cooling slots 18 shown in FIGS. 1A-1B or the cooling slots 94 shown in FIGS. 4A-4B, in the grille-structure that allow fluid communication through the grille-structure, the plurality of cooling slots spaced along a first axis, e.g., the axis 24 shown in FIGS. 1A-1B and FIGS. 4A-4B, in a sequence of increasing circumferential lengths, e.g., such as the sequence of cooling slots 18a, 18b, 18c, 18d shown in FIGS. 1A-1B or the sequence of cooling slots 94a, 94b, 94c, 94d shown in FIGS. 4A-4B. In block 1006, the method includes forming a plurality of cooling holes, e.g., such as the cooling holes 20 shown in FIGS. 1A-1B or the cooling holes 96 shown in FIGS. 4A-4B, in the grille-structure that allow fluid communication through the grille-structure, the plurality of cooling holes located about the plurality of cooling slots.

Looking now at FIG. 11, a block diagram of an example method 1100 of using an engine grille, e.g., the grille 10 shown in FIGS. 1A-1B, or the grille 86 shown in FIGS. 4A-4B, in connection with operation of an engine is shown, in accordance with an embodiment of the present disclosure. The method 1100 includes blocks 1102-1104, but is not limited to this combination of elements. In block 1102, the method includes operating an engine coupled to the grille in a first operational state, e.g., a “cooling-associated” operational state, as discussed in connection with FIGS. 8A-8B, to thereby generate a first ratio of fluid transfer over/around the grille. In block 1104, the method includes operating the engine coupled to the grille in a second operational state, e.g., an “aerodynamically-associated” operational state, as discussed in connection with FIGS. 8A-8B, to thereby generate a second ratio of fluid transfer over/around the grille.

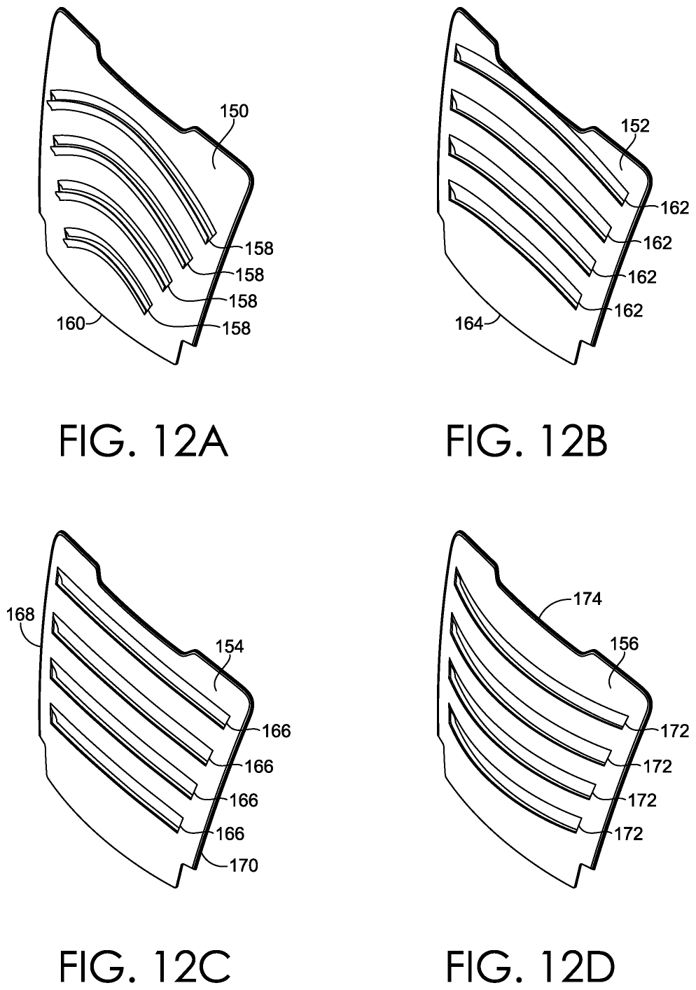

Looking now at FIGS. 12A-12D, a series of grilles 150, 152, 154, 156 having alternative configurations that also support cooling/aerodynamic benefits as described herein are shown, in accordance with embodiments hereof. The grilles 150, 152, 154, 156 each include a plurality of elongated cooling slots. Like the other embodiments described herein, the cooling slots can be different lengths, widths, heights, and/or depths, and may have different radii of curvature, spacing, or ratios of the same.

Looking now at FIG. 12A, the grille 150 includes a plurality of elongated cooling slots 158 that extend through the grille 150 and that are arranged in a sequence of increasing circumferential lengths. The cooling slots 158 are arcuate-shaped, or rather, are curved. In FIG. 12A, the concave side of each cooling slot 158 is oriented toward a bottom edge 160 of the grille 150 (e.g., a portion of the grille 150 closest to the ground in the in-use configuration/orientation). The grille 150 does not include circular cooling holes, e.g., such as those shown on the grille 10 in FIGS. 1A-1B, but in other embodiments, the grille 150 may include any number of such cooling holes to enhance fluid transfer during a cooling operation.

Looking now at FIG. 12B, the grille 152 includes a plurality of elongated cooling slots 162 that extend through the grille 152 and that are arranged in a sequence of increasing circumferential lengths. The cooling slots 162 are arcuate-shaped, or rather, are curved, similar to the cooling slots 158 shown in FIG. 12A. The concave side of each cooling slot 162 is again oriented toward a bottom edge 164 of the grille 152 (e.g., a portion of the grille 152 closest to the ground in the in-use configuration/orientation). However, the radius of curvature of each cooling slot 162 is larger than a radius of curvature of the corresponding cooling slots 158 shown in FIG. 12A. In other words, each cooling slot 162 has a flatter, more gradual curvature. This difference in radius of curvature can be between 1-1,000 centimeters, in different aspects. The grille 152 does not include circular cooling holes, e.g., such as those shown on the grille 10 in FIGS. 1A-1B, but in other embodiments, the grille 152 may include any number of such cooling holes to enhance fluid transfer during a cooling operation.

Looking now at FIG. 12C, the grille 154 includes a plurality of elongated cooling slots 166 that extend through the grille 154 and that are arranged in a sequence of increasing lengths. In this aspect, the cooling slots 166 are substantially linear or flat, or rather have substantially no curvature, extending between opposite sides 168, 170 of the grille 154. The cooling slots 166 may increase in length by a common amount, or by different amounts. For example, the change in length between each cooling slot 166 may be 1 to 50 centimeters, as with other aspects herein. The spacing between the cooling slots 166 may also be the same or different. For example, each spacing may be 1 to 50 centimeters, as with other aspects herein. The grille 154 does not include circular cooling holes, e.g., such as those shown on the grille 10 in FIGS. 1A-1B, but in other embodiments, the grille 154 may include any number of such cooling holes to enhance fluid transfer during a cooling operation.

Looking now at FIG. 12D, the grille 156 includes a plurality of elongated cooling slots 172 that extend through the grille 156 and that are arranged in a sequence of increasing circumferential lengths. The cooling slots 172 are arcuate-shaped similar to the cooling slots 158, 162 shown in FIGS. 12A and 12B. However, the cooling slots 172 have a differently oriented curvature. In particular, the cooling slots 172 each have a concave side that is oriented toward a top edge 174 of the grille 156 (e.g., a portion of the grille 156 farthest from the ground in the in-use configuration/orientation). The grille 156 does not include circular cooling holes, e.g., such as those shown on the grille 10 in FIGS. 1A-1B, but in other embodiments, the grille 156 may include any number of such cooling holes to enhance fluid transfer during a cooling operation.

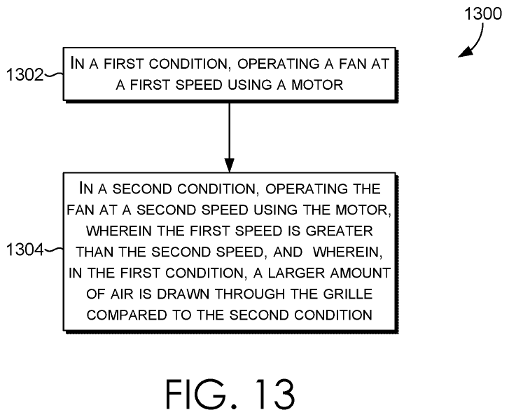

Looking now at FIG. 13, a block diagram of a method 1300 of differentially controlling airflow through and/or around a grille, e.g., the grille 10 or the grille 86 depicted herein, attached to a vehicle, e.g., the vehicle 75 depicted herein, that includes a fan and a motor, e.g., the fan/motor 142 depicted herein, is provided, in accordance with embodiments of the present disclosure. In block 1302, the method 1300 includes, in a first condition, operating the fan at a first speed using the motor. The first condition may be associated with a higher engine output that generates a higher heat load, and thus may be associated with a cooling condition. In block 1304, the method 1300 includes, in a second condition, operating the fan at a second speed using the motor, wherein the first speed is greater than the second speed, and wherein, in the first condition, a larger amount of air is drawn through the grille compared to the second condition (e.g., based on volumetric flow rate as measured by meters cubed/second). The second condition can be associated with a reduced or lower engine output that generates a lower heat load relative to the first condition, and thus may be associated with a cruising condition (e.g., where the vehicle is traveling at a greater speed and with less engine load than in the first condition). The cruising condition, as described herein, can be a condition associated with primarily RAM air. The cruising condition can also be associated with a fan attached to the engine operating at a reduced output, operating in an idle state, or being turned off.

In embodiments, a grille may include a plurality of cooling holes, openings, and/or apertures, e.g., arranged in a disbursed pattern on the grille, without there being any elongated cooling slots (e.g., such as those having a linear, substantially linear, or arcuate shape as described herein). In such aspects, the cooling holes, openings, and/or apertures can have different shapes, e.g., circular, oval, elliptical, racetrack, square, triangular, or another polygonal shape, and may be symmetrical in shape, partially symmetrical in shape, and/or asymmetrical in shape, in different aspects. The cooling holes, openings, and/or apertures can also incorporate the geometries used with the elongated cooling slots described herein to thereby achieve similar cooling/aerodynamic benefits with a distributed configuration of cooling holes, openings, and/or apertures. For example, the cooling holes, openings, and/or apertures can have the cross-sectional configuration or geometry shown in FIG. 2 or in FIG. 5, among other possible configurations. In different aspects, the grilles may include any number of such cooling holes, openings, and/or apertures, and densities thereof in different areas of a grille, either with or without elongated cooling slots as described herein.

In an embodiment, a grille may include a plurality of cooling slots formed therein. The plurality of cooling slots can be linear-shaped cooling slots and/or arc-shaped cooling slots. The plurality of cooling slots, if arc-shaped, can include one or more of a first arc-shaped cooling slot having a circumferential length of 400 millimeters-500 millimeters and having a radius of 15 millimeters-50 millimeters; a second arc-shaped cooling slot having a circumferential length of 580 millimeters-680 millimeters and having a radius of 15 millimeters-50 millimeters; a third arc-shaped cooling slot having a circumferential length of 760 millimeters-860 millimeters and having a radius of 15 millimeters-50 millimeters; and a fourth arc-shaped cooling slot having a circumferential length of 940 millimeters-1,040 millimeters and having a radius of 15 mm-50 mm.

The engine grilles, assemblies with engine grilles, and methods of manufacturing and using the same that are disclosed herein may be applicable to a range of vehicle sizes, classes, and types. For example, the aforementioned aspects may be used with internal combustion engine (“ICE”) vehicles, electric vehicles (“EV”), battery electric vehicles (“BEV”), hybrid electric vehicles (“HEV”), plug-in electric vehicles (“PHEV”), and with fuel-cell electric vehicles (“FCEV”), among others.

Clause 1. A grille for an engine, comprising: a first surface; a second surface facing opposite from the first surface; and a plurality of cooling slots that allow fluid communication through the first surface and the second surface of the grille, the plurality of cooling slots spaced along a first axis in a sequence of increasing lengths.

Clause 2. The grille of clause 1, wherein each cooling slot comprises an arc-shaped cooling slot, wherein the first axis is a vertical axis extending between a bottom of the grille and a top of the grille, and wherein the sequence of increasing lengths extends towards the top of the grille.

Clause 3. The grille of clause 1 or 2, wherein each cooling slot defines a channel extending through the grille.

Clause 4. The grille of any of clauses 1-3, wherein each cooling slot further comprises: a first extension, the first extension including a first extension surface and a second extension surface facing opposite from the first extension surface, the first extension surface being continuous with the first surface of the grille, and the second extension surface being continuous with the second surface of the grille, wherein the first extension surface extends through the cooling slot thereby defining at least part of the channel.

Clause 5. The grille of any of clauses 1-4, wherein each cooling slot further comprises: a second extension, the second extension including a third extension surface and a fourth extension surface facing opposite from the third extension surface, the third extension surface being continuous with the first surface of the grille, and the fourth extension surface being continuous with the second surface of the grille, wherein the fourth extension surface extends through the cooling slot thereby defining at least part of the channel, and wherein the first extension and the second extension extend in generally opposite directions.

Clause 6. The grille of any of clauses 1-5, wherein the first extension surface is curved, wherein the fourth extension surface is curved, and wherein the first extension surface and the fourth extension surface face at least partially towards each other.

Clause 7. The grille of any of clauses 1-6, further comprising a plurality of cooling holes each extending through the first surface and the second surface of the grille, the plurality of cooling holes located about the plurality of cooling slots, wherein each one of the plurality of cooling holes is defined by a first aperture in the first surface, a second aperture in the second surface, and a sidewall extending between the first aperture in the first surface and the second aperture in the second surface.

Clause 8. The grille of any of clauses 1-7, wherein the first aperture in the first surface has a larger diameter than the second aperture in the second surface, and wherein the sidewall defines, at least in part, a funnel shape and/or a conical shape.

Clause 9. The grille of any of clauses 1-8, wherein the plurality of cooling slots comprises one or more of: a cooling slot having a length of 400 millimeters-500 millimeters; a cooling slot having a length of 580 millimeters-680 millimeters; a cooling slot having a length of 760 millimeters-860 millimeters; and a cooling slot having a length of 940 millimeters-1,040 millimeters.

Clause 10. An assembly for an engine of a vehicle, comprising: a mount attachable to a frame of the vehicle; a grille attachable to the mount, the grille comprising: a first surface, a second surface facing opposite from the first surface, and a plurality of cooling slots that allow fluid communication through the first surface and the second surface of the grille, the plurality of cooling slots spaced along a first axis in a sequence of increasing lengths.

Clause 11. The assembly of clause 10, wherein each cooling slot comprises an arc-shaped cooling slot.

Clause 12. The assembly of clause 10 or 11, wherein each cooling slot defines a channel extending through the grille.

Clause 13. The assembly of any of clauses 10-12, wherein each cooling slot further comprises: a first extension, the first extension including a first extension surface and a second extension surface facing opposite from the first extension surface, the first extension surface being continuous with the first surface of the grille, and the second extension surface being continuous with the second surface of the grille, wherein the first extension surface extends through the cooling slot thereby defining at least part of the channel.

Clause 14. The assembly of any of clauses 10-13, wherein each cooling slot further comprises: a second extension, the second extension including a third extension surface and a fourth extension surface facing opposite from the third extension surface, the third extension surface being continuous with the first surface of the grille, and the fourth extension surface being continuous with the second surface of the grille, wherein the fourth extension surface extends through the cooling slot thereby defining at least part of the channel, and wherein the first extension and the second extension extend in generally opposite directions.

Clause 15. The assembly of any of clauses 10-14, further comprising a plurality of cooling holes that each extend through the first surface and the second surface of the grille, the plurality of cooling holes located about the plurality of cooling slots, wherein each one of the plurality of cooling holes is defined by a first aperture in the first surface, a second aperture in the second surface, and a sidewall extending between the first aperture in the first surface and the second aperture in the second surface.

Clause 16. The assembly of any of clauses 10-15, wherein the first aperture in the first surface has a larger diameter than the second aperture in the second surface, and wherein the sidewall defines, at least in part, a funnel shape and/or a conical shape.

Clause 17. A method for differentially controlling airflow around and/or through a grille attached to a vehicle propelled at least in part by an engine, wherein the grille comprises a grille according to any of clauses 1-9, the method comprising: in a first condition, operating the engine at a first load condition; and in a second condition, operating the engine at a second load condition, wherein the first load condition is greater than the second load condition, and wherein, in the first condition, a greater amount of air is drawn through the grille as compared to the second condition.

Clause 18. The method of clause 17, further comprising controlling a motor operably coupled to a fan of the vehicle so as to control the fan at a first speed in the first condition, and at a second speed in the second condition, wherein the first speed is greater than the second speed.

Clause 19. The method of clause 17 or 18, wherein, in the first condition, the vehicle is traveling at a first vehicle speed, wherein, in the second condition, the vehicle is traveling at a second vehicle speed, and wherein the second vehicle speed is greater than the first vehicle speed.

Clause 20. The method of any of clauses 17-19, wherein, in the second condition, a higher volume of air is directed over and/or around the grille as compared to the first condition.

Clause 21. A method of using a grille comprising a first surface, a second surface, and a plurality of cooling slots and/or a plurality of cooling holes, the method comprising operating an engine attached to the grille in a first operational state to thereby generate a first ratio of fluid transfer through/around the grille; and operating the engine coupled to the grille in a second operational state to thereby generate a second ratio of fluid transfer through/around the grille.

Clause 22. A grille for an engine comprising a first surface; a second surface facing opposite from the first surface; and a plurality of arc-shaped cooling slots that allow fluid communication through the first surface and the second surface of the grille, the plurality of arc-shaped cooling slots spaced along a first axis in a sequence of increasing circumferential lengths.

Clause 23. The grille of clause 22, further comprising a plurality of cooling holes formed in the grille that allow fluid communication through the first surface and the second surface of the grille.

Clause 24. The grille of clause 22 or 23, wherein the plurality of arc-shaped cooling slots are, at least in part, substantially parallel tangentially.

Clause 25. The grille of clause 22 or 23, wherein the plurality of arc-shaped cooling slots are not substantially parallel tangentially.

Clause 26. The grille of any of clauses 22-25, wherein the sequence of arc-shaped cooling slots extends radially along a vertical axis of the grille between a bottom of the grille and a top of the grille.

Clause 27. The grille of any of clauses 22-26, wherein an apex of each arc-shaped cooled slot is aligned with a vertical axis and/or a central axis of the grille.

Clause 28. The grille of any of clauses 22-27, wherein at least 5 percent, at least 10 percent, at least 15 percent, at least 20 percent, at least 25 percent, at least 30 percent, at least 35 percent, at least 40 percent, at least 45 percent, or at least 50 percent, or more, of a surface of the grille is occupied by the plurality of arc-shaped cooling slots.

Clause 29. The grille of any of clauses 22-28, wherein the circumference of each arc-shaped cooling slot extends generally along a horizontal axis of the grille, or wherein the circumference of each arc-shaped cooling slot extends generally along a vertical axis of the grille.

Clause 30. The grille of any of clauses 22-29, wherein a circumference of each one of the plurality of arc-shaped cooling slots extends between 20% and 90% of a width of the grille if oriented along its horizontal axis, or wherein a circumference of each one of the plurality of arc-shaped cooling slots extends between 20% and 90% of a height of the grille if oriented along its vertical axis.

Clause 31. A method of manufacturing a grille according to any of the embodiments or clauses herein.

Clause 32. A method of integrating a grille according to any of the embodiments or clauses herein into a vehicle.

Clause 33. A vehicle comprising a grille according to any of the embodiments or clauses herein.

Clause 34. A freight tractor comprising a grille according to any of the embodiments or clauses herein.

In some embodiments, this disclosure may include the language, for example, “at least one of [element A] and [element B].” This language may refer to one or more of the elements. For example, “at least one of A and B” may refer to “A,” “B,” or “A and B.” In other words, “at least one of A and B” may refer to “at least one of A and at least one of B,” or “at least either of A or B.” In some embodiments, this disclosure may include the language, for example, “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements. In addition, this disclosure may refer to “a” element or “the” element. This language may refer to the referenced element in the singular or in the plural, and is not intended to be limiting in this respect.

The subject matter of this disclosure has been described in relation to particular embodiments, which are intended in all respects to be illustrative rather than restrictive. In this sense, alternative embodiments will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

1. A grille for an engine, comprising: a first surface; a second surface facing opposite from the first surface; and a plurality of cooling slots that allow fluid communication through the first surface and the second surface of the grille, the plurality of cooling slots spaced along a first axis in a sequence of increasing lengths.

2. The grille of claim 1, wherein each cooling slot comprises an arc-shaped cooling slot, wherein the first axis is a vertical axis extending between a bottom of the grille and a top of the grille, and wherein the sequence of increasing lengths extends towards the top of the grille.

3. The grille of claim 1, wherein each cooling slot defines a channel extending through the grille.

4. The grille of claim 3, wherein each cooling slot further comprises: a first extension, the first extension including a first extension surface and a second extension surface facing opposite from the first extension surface, the first extension surface being continuous with the first surface of the grille, and the second extension surface being continuous with the second surface of the grille, wherein the first extension surface extends through the cooling slot thereby defining at least part of the channel.

5. The grille of claim 4, wherein each cooling slot further comprises: a second extension, the second extension including a third extension surface and a fourth extension surface facing opposite from the third extension surface, the third extension surface being continuous with the first surface of the grille, and the fourth extension surface being continuous with the second surface of the grille, wherein the fourth extension surface extends through the cooling slot thereby defining at least part of the channel, and wherein the first extension and the second extension extend in generally opposite directions.

6. The grille of claim 5, wherein the first extension surface is curved, wherein the fourth extension surface is curved, and wherein the first extension surface and the fourth extension surface face at least partially towards each other.

7. The grille of claim 1, further comprising a plurality of cooling holes each extending through the first surface and the second surface of the grille, the plurality of cooling holes located about the plurality of cooling slots, wherein each one of the plurality of cooling holes is defined by a first aperture in the first surface, a second aperture in the second surface, and a sidewall extending between the first aperture in the first surface and the second aperture in the second surface.

8. The grille of claim 7, wherein the first aperture in the first surface has a larger diameter than the second aperture in the second surface, and wherein the sidewall defines, at least in part, a funnel shape and/or a conical shape.

9. The grille of claim 1, wherein the plurality of cooling slots comprises one or more of: a cooling slot having a length of 400 millimeters-500 millimeters; a cooling slot having a length of 580 millimeters-680 millimeters; a cooling slot having a length of 760 millimeters-860 millimeters; and a cooling slot having a length of 940 millimeters-1,040 millimeters.

10. An assembly for an engine of a vehicle, comprising: a mount attachable to a frame of the vehicle; a grille attachable to the mount, the grille comprising: a first surface, a second surface facing opposite from the first surface, and a plurality of cooling slots that allow fluid communication through the first surface and the second surface of the grille, the plurality of cooling slots spaced along a first axis in a sequence of increasing lengths.

11. The assembly of claim 10, wherein each cooling slot comprises an arc-shaped cooling slot.

12. The assembly of claim 10, wherein each cooling slot defines a channel extending through the grille.

13. The assembly of claim 12, wherein each cooling slot further comprises: a first extension, the first extension including a first extension surface and a second extension surface facing opposite from the first extension surface, the first extension surface being continuous with the first surface of the grille, and the second extension surface being continuous with the second surface of the grille, wherein the first extension surface extends through the cooling slot thereby defining at least part of the channel.

14. The assembly of claim 13, wherein each cooling slot further comprises: a second extension, the second extension including a third extension surface and a fourth extension surface facing opposite from the third extension surface, the third extension surface being continuous with the first surface of the grille, and the fourth extension surface being continuous with the second surface of the grille, wherein the fourth extension surface extends through the cooling slot thereby defining at least part of the channel, and wherein the first extension and the second extension extend in generally opposite directions.

15. The assembly of claim 10, further comprising a plurality of cooling holes that each extend through the first surface and the second surface of the grille, the plurality of cooling holes located about the plurality of cooling slots, wherein each one of the plurality of cooling holes is defined by a first aperture in the first surface, a second aperture in the second surface, and a sidewall extending between the first aperture in the first surface and the second aperture in the second surface.

16. The assembly of claim 15, wherein the first aperture in the first surface has a larger diameter than the second aperture in the second surface, and wherein the sidewall defines, at least in part, a funnel shape and/or a conical shape.

17. A method for differentially controlling airflow around and/or through a grille attached to a vehicle propelled at least in part by an engine, the method comprising: in a first condition, operating the engine at a first load condition; and in a second condition, operating the engine at a second load condition, wherein the first load condition is greater than the second load condition, and wherein, in the first condition, a greater amount of air is drawn through the grille as compared to the second condition, wherein the grille comprises a plurality of cooling slots that allow fluid communication through the grille, the plurality of cooling slots spaced along a first axis in a sequence of increasing lengths.

18. The method of claim 17, further comprising controlling a motor operably coupled to a fan of the vehicle so as to control the fan at a first speed in the first condition, and at a second speed in the second condition, wherein the first speed is greater than the second speed.

19. The method of claim 17, wherein, in the first condition, the vehicle is traveling at a first vehicle speed, wherein, in the second condition, the vehicle is traveling at a second vehicle speed, and wherein the second vehicle speed is greater than the first vehicle speed.

20. The method of claim 17, wherein, in the second condition, a higher volume of air is directed over and/or around the grille as compared to the first condition.
